(19) United States
(12) Patent Application Publication
(10) Pub. No.: US 2005/0221137 A1
(43) Pub. Date: Oct. 6, 2005

(54) Fuel humidifier and pre-heater for use in a fuel cell system

(76) Inventors: Todd Bandhauer, Racine, WI (US); Mark G. Voss, Franksville, WI (US); Nicholas Siler, Franksville, WI (US); Michael McGregor, Racine, WI (US); Michael J. Reinke, Franklin, WI (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 11/079,057

(22) Filed: Mar. 14, 2005

Related U.S. Application Data
(60) Provisional application No. 60/558,285, filed on Mar. 31, 2004.

(51) Int. Cl. H01M 8/18; F02G 3/00; H01M 8/04; H01M 8/12; F02C 9/00

(52) U.S. Cl. 429/24; 429/17; 429/19

(57) ABSTRACT

A fuel humidifier/pre-heater system (10) is provided for pre-heating and humidifying a fuel flow, and is particularly useful for pre-heating and humidifying a fuel flow for a fuel cell, particularly molten-carbonate fuel cells (60). The system includes a steam generator (12), a water bypass (18), a liquid/steam mixer (20), and a mixture heater (14). The humidified fuel outlet temperature of the system is controlled by bypassing a portion of the water flow around the steam generator (12) so as to control the amount of superheat. The steam is then mixed with the fuel, and then the fuel/steam mixture is heated in the mixture heater (14). Additionally, a fuel bypass (16) can be provided for further temperature control by bypassing a portion of the fuel around the mixture heater (14) and then mixing the bypassed fuel with the steam/fuel mixture that has passed through the mixture heater (14).

### FIELD OF THE INVENTION

This invention relates to fuel humidifiers and pre-heaters, and in more particular applications, to fuel humidifiers and preheaters for use in fuel cell systems, particularly molten-carbonate fuel cell systems.

### BACKGROUND OF THE INVENTION

A molten-carbonate fuel cell (MCFC) produces electricity by reacting hydrogen with oxygen and carbon dioxide. The electrolyte of an MCFC is molten mixture of alkali carbonates, which form a highly conductive salt at high temperatures (typically 600 to 700° C.). The carbonate CO₃²⁻ is formed at the cathode by reacting carbon dioxide with oxygen, and passes through the electrolyte to the anode, where it reacts with hydrogen to form water. The electrons formed at the cathode do not pass through the electrolyte, and thus pass through an external circuit. The cathode, anode, and net reactions are summarized as follows:
O₂+2CO₂+4e⁻ 2CO₃² (Cathode)
H₂+2CO₃²⁻ 2H₂O+2CO₂+4e⁻ (Anode)
H₂+½O₂+CO₂ H₂O+CO₂ (Net)

The hydrogen is usually generated from a hydrocarbon (i.e., natural gas, propane, coal, etc.) internal to or upstream of the MCFC via the highly endothermic steam reforming reaction. In either case, a fuel needs to be pre-heated and humidified to a specified temperature using a hot gas (for example cathode exhaust gas (CEG)). In addition, an MCFC typically requires long start-up times (i.e., transient conditions on the order of days), and can be operated under a variety of load conditions. These conditions can consist of at least variable steam to fuel ratios, steam and fuel flow rates, and variable hot gas inlet temperatures and flow rates. An example of this is shown in Table 1. Cases 4 and 5 represent two stages of start-up (end and beginning, respectively) with the remaining cases comprising various electrical power outputs.

TABLE 1
Case Summary

| | | | | | | | Mixture | | |
|---|---|---|---|---|---|---|---|---|---|
| | CEG | | Water | | Fuel | | Delivery | Relative to Case 6 | |
| | Flow | Inlet | Flow | Inlet | Flow | Inlet | Outlet | CEG | Mixture |
| | Rate | Temperature | Rate | Temperature | Rate | Temperature | Temperature | Flow | Flow |
| Case | kg/hr | ° C. | kg/hr | ° C. | kg/hr | ° C. | ° C. | Rate | Rate |
| 1 | 1096 | 601.7 | 85.7 | 15 | 39 | 15 | 400 | 43% | 51% |
| 2 | 2296 | 612.2 | 100.7 | 15 | 61.7 | 15 | 400 | 90% | 67% |
| 3 | 1329 | 606.7 | 83.9 | 15 | 38.1 | 15 | 400 | 52% | 50% |
| 4 | 334.3 | 555 | 22.7 | 15 | 2.7 | 15 | 400 | 13% | 10% |
| 5 | 334.3 | 371 | 22.7 | 15 | 2.7 | 15 | — | 13% | 10% |
| 6 | 2539 | 612.2 | 156.5 | 15 | 87.7 | 15 | 400 | 100% | 100% |

There is a continuing need for new and improved systems and methods for humidifying and heating the fuel for fuel cell systems, and in particular for MCFC systems.

### SUMMARY OF THE INVENTION

In accordance with one feature of the invention, a fuel humidifier/pre-heater unit is provided for pre-heating and humidifying a fuel flow provided by a fuel supply.

According to one feature of the invention, a fuel cell system is provided and includes a molten-carbonate fuel cell and a fuel humidifier/pre-heater unit for pre-heating and humidifying a fuel flow to the molten-carbonate fuel cell.

In one feature, the unit includes a steam generator, a water bypass, a liquid/steam mixer, and a mixture heater. The steam generator includes a water flow path in heat transfer relation with a hot fluid flow path to generate a vaporized water flow. The liquid/steam mixer is connected downstream from the water flow path to receive the vaporized water flow therefrom and downstream from the water bypass to receive a liquid water flow therefrom. The mixture heater includes a mixture flow path in heat transfer relation with a hot fluid flow path, the mixture flow path being connected downstream from the liquid/vapor mixer and the fuel supply.

According to one feature, the hot fluid flow path of the steam generator is located downstream from the hot fluid flow path of the mixture heater with respect to a hot fluid flow.

According to another feature, the hot fluid flow path of the mixture heater is located downstream from the hot fluid flow path of the steam generator with respect to a hot fluid flow.

In one feature, the unit further includes a water bypass control valve connected upstream of the steam generator and the water bypass to selectively direct liquid water flows thereto.

In accordance with one feature, the steam generator and the liquid/steam mixer are an integrated unit.

In accordance with another feature, the liquid/steam mixer is located external from the steam generator.

According to one feature, the unit further includes a steam/fuel mixer connected downstream from the liquid/steam mixer to receive a superheated steam flow therefrom, downstream from the fuel supply to receive a fuel flow therefrom, and upstream from the mixture flow path to supply a steam/fuel mixture thereto.

In one feature, the unit further includes a fuel bypass, and a fuel/humidified fuel mixer connected downstream from the mixture heater to receive a humidified fuel flow therefrom and connected downstream from the fuel bypass to receive a fuel flow therefrom. In a further feature, the unit further includes a fuel bypass control valve connected upstream from the fuel bypass and the mixture heater with respect to the fuel flow.

According to one feature, the steam generator includes a helical-wound tube with a water inlet and a steam outlet. The water inlet is located vertically lower than the steam outlet.

In accordance with one form of the invention, a method is provided for humidifying and pre-heating a fuel flow. The method includes the steps of:
a) providing a fuel flow
b) providing a water flow for humidifying of a fuel flow;
c) modulating an amount of superheat of the water flow by heating a first portion of the supply water flow and mixing the heated first portion with a second portion of the supply water flow that has a lower temperature than the first portion;
d) mixing the water flow resulting from step c) with at least a first portion of the fuel flow to provide a mixture flow; and
e) heating the mixture flow.

In one feature, the superheating of step c) and the heating of step e) are accomplished by transferring heat from a hot fluid flow to the water flow in step c) and the mixture flow in step e).

According to one feature, the hot fluid flow transfers heat in step c) before it transfers heat in step e).

According to another feature, the hot fluid flow transfers heat in step e) before it transfers heat in step c).

In one feature, step d) includes mixing the water flow resulting from step c) with all of the fuel flow.

In accordance with one feature, step c) includes selectively adjusting the first and second portions of the water flow to achieve a desired temperature for the mixture flow resulting from step e).

According to one feature, the method further includes the step of f) modulating the temp of the humidified and pre-heated fuel flow by mixing the mixture flow resulting from step d) with a second portion of the fuel flow that has not been heated in step e).

In one feature, step f) includes selectively adjusting the first and second portions of the fuel flow to achieve a desired temperature for the mixture flow resulting from step f). In a further feature, step c) includes selectively adjusting the first and second portions of the water flow to achieve the desired temperature for the mixture flow resulting from step f).

In one feature, step c) further comprises superheating the first portion prior to mixing the first and second portions.

Other objects, features, and advantages of the invention will become apparent from a review of the entire specification, including the appended claims and drawings.

### BRIEF DESCRIPTION OF THE DRAWINGS

FIG. 1 is a diagrammatic representation of a fuel humidifier/pre-heater system embodying the present invention;

FIG. 2 is a diagrammatic representation of another fuel humidifier/pre-heater system embodying the present invention;

FIG. 3A is a perspective view of a fuel humidifier/pre-heater assembly made according to FIG. 1;

FIG. 3B is an enlarged, perspective view of a liquid/steam mixer or attemperator shown in FIG. 3A;

FIG. 3C is an enlarged, perspective view of a water bypass and control of FIG. 3A;

FIG. 3D is an enlarged, perspective view of a fuel/steam mixer of FIG. 3A;

FIG. 3E is an enlarged, perspective view of a fuel bypass and control of FIG. 3A;

FIG. 3F is an enlarged, perspective view of a fuel/humidified fuel mixer of FIG. 3A;

FIG. 3G is an enlarged, perspective view of a mixture heater of FIG. 3A;

FIG. 3H is an enlarged, partially broken, perspective view of a steam generator of FIG. 3A; and

FIG. 4 is an elevation view of another embodiment of a steam generator that can be employed in embodiments of the invention.

### DETAILED DESCRIPTION OF THE PREFERRED EMBODIMENTS

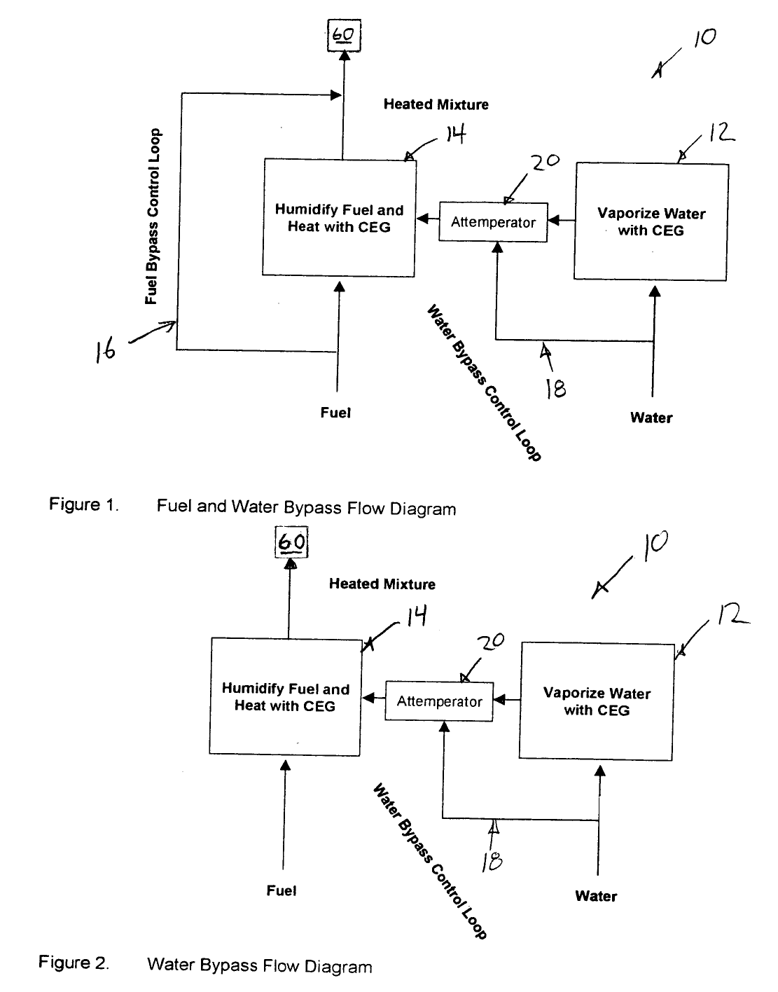

Two embodiments of a fuel humidifier/pre-heater unit or system 10 are shown in FIGS. 1 and 2. Essential to the design of this system 10 is the separation of fuel pre-heating and steam generation, which prevents coking of hydrocarbon fuel (this usually happens when un- or under-humidified fuel is in contact with a hot surface (>350° C.)). Steam is generated via heat exchange with the hot gas (CEG). This also allows separation of induced two-phase thermal stresses inherent in steam generation from fuel pre-heating, as well as reducing the fuel pressure drop. Also essential to the design is mixing the superheated steam with unheated fuel outside the hot gas stream (prevents unwanted coking), and that this final mixture be at least saturated, but preferably superheated.

Moreover, steam may be generated and mixed with the fuel to obtain the desired temperature. However, the steam may not be able to reach the required temperature, as in the continued example (see Table 2). For cases 1, 2, 3 and 6, a fuel pre-heater is required.

TABLE 2
Required Steam Temperature Without Fuel Pre-Heating

| | CEG Inlet Temperature | Required Steam Temperature |
|---|---|---|
| Case | ° C. | ° C. |
| 1 | 601.7 | 620.1 |
| 2 | 612.2 | 693.2 |
| 3 | 606.7 | 619.7 |
| 4 | 555 | 457.8 |
| 5 | 371 | 400.7 |
| 6 | 612.2 | 615.9 |

A major difficulty of this invention is the control mechanism. The hot and cold (i.e., fuel and steam) fluids do not necessarily follow the same turn down ratio. For example, Table 1 shows the fraction of CEG and saturated mixture (after the steam and fuel have been fully mixed) relative to max operation. To accommodate the variable nature of turndown and start-up, the humidified fuel temperature delivered to the stack or reformer can be controlled by bypassing all or a portion of the fuel. However, during start-up, the hot gas temperature can increase to temperatures too high for even 100% fuel bypass. Table 1 shows that the beginning (case 5) and end (case 4) of start-up have the same flow rates, but a difference in Entering Temperature Differential (ETD) between the fuel/steam and the CEG of 184° C. With an adequate steam generator 12 for the beginning of start-up, and an adequate mixture heater 14 (to heat the fuel and steam) for full load, the mixture temperature in case 4 cannot be lowered by fuel bypass alone (see Table 3 for mixture heater performance).

TABLE 3
Fuel Bypass Control Example

| | Units | Case 1 | Case 2 | Case 3 | Case 4 | Case 5 | Case 6 |
|---|---|---|---|---|---|---|---|
| Cathode Exhaust | | | | | | | |
| Flow Rate | kg/hr | 1096 | 2296 | 1329 | 334 | 334 | 2539 |
| Inlet Temperature | C. | 602 | 612 | 607 | 555 | 371 | 612 |
| Outlet Temperature | C. | 559 | 589 | 578 | 528 | 344 | 573 |
| Mixture | | | | | | | |
| Flow Rate | kg/hr | 115 | 129 | 107 | 23 | 25 | 242 |
| Inlet Temperature | C. | 215 | 291 | 263 | 324 | 128 | 175 |
| Outlet Temperature | C. | 433 | 487 | 449 | 536 | 327 | 406 |
| Fuel Bypass Required | % | 25% | 54% | 39% | 100% | 0% | 0% |
| Delivered Fuel Cell Temp | C. | 400 | 400 | 400 | 486 | 327 | 400 |

Ideally, only low temperature valves are used to control the system. The first suggested control embodiment is to use a fuel bypass 16 in conjunction with a liquid water bypass 18 around or to the end of the steam generator (see FIG. 1). The bypassed water mixes with the steam in an attemperator 20 (which can be located inside of or external to the steam generator 12) such that it produces steam with enough superheat to prevent water condensation when mixed with the cold fuel. Table 4 shows the results of this embodiment with liquid water bypass only during the end of start-up. This table shows that the required outlet temperature is met for the required cases (1-4 and 6). Variable liquid water flow could also be used in all other cases in conjunction with reduced fuel bypass.

TABLE 4
Fuel and Water Bypass Control Example

| | | | | | | |
|---|---|---|---|---|---|---|
| Units | Case 1 | Case 2 | Case 3 | Case 4 | Case 5 | Case 6 |

Mixture Heater

| | | | | | | | |
|---|---|---|---|---|---|---|---|
| Cathode Exhaust | | | | | | | |
| Flow Rate | kg/hr | 1096 | 2296 | 1329 | 334 | 334 | 2539 |
| Inlet Temperature | C. | 602 | 612 | 607 | 555 | 371 | 612 |
| Outlet Temperature | C. | 564 | 592 | 581 | 516 | 349 | 575 |
| Mixture | | | | | | | |
| Flow Rate | kg/hr | 112 | 137 | 103 | 24 | 25 | 242 |
| Inlet Temperature | C. | 246 | 304 | 303 | 116 | 146 | 196 |
| Outlet Temperature | C. | 448 | 479 | 484 | 436 | 304 | 400 |
| Fuel | | | | | | | |
| Flow Rate | kg/hr | 39.0 | 61.7 | 38.1 | 2.7 | 2.7 | 85.7 |
| Bypass Required | % | 32% | 41% | 51% | 64% | 0% | 0% |
| Delivered Fuel Cell Temp | C. | 400 | 400 | 400 | 400 | 304 | 400 |

Steam Generator

| | | | | | | | |
|---|---|---|---|---|---|---|---|
| Cathode Exhaust | | | | | | | |
| Flow Rate | kg/hr | 1096 | 2296 | 1329 | 334 | 334 | 2539 |
| Inlet Temperature | C. | 564 | 592 | 581 | 516 | 349 | 575 |
| Outlet Temperature | C. | 375 | 474 | 419 | 359 | 178 | 422 |
| Water | | | | | | | |
| Flow Rate | kg/hr | 85.7 | 100.7 | 83.9 | 22.7 | 22.7 | 156.5 |
| Bypass Required | % | 0% | 0% | 0% | 15% | 0% | 0% |
| Inlet Temperature | C. | 15 | 15 | 15 | 15 | 15 | 15 |
| Outlet Temperature | C. | 334 | 434 | 384 | 356 | 164 | 315 |
| Steam Pressure Drop | kPa | 72 | 115 | 87 | 12 | 6 | 126 |

The second suggested control embodiment is to use only the water bypass 18 to control the humidified fuel temperature (see FIG. 2). Again, the bypassed liquid water is mixed with the superheated steam in the attemperator 20 (which can be located inside of or external to the steam generator). The product steam will also have enough heat to prevent condensing when mixed with the cold fuel. Table 5 shows the results of liquid only bypass for the current example. This table shows that the required outlet temperature is met for the required cases (1-4 and 6).

TABLE 5
Water Bypass Control Example

| | | | | | | |
|---|---|---|---|---|---|---|
| Units | Case 1 | Case 2 | Case 3 | Case 4 | Case 5 | Case 6 |

Mixture Heater

| | | | | | | | |
|---|---|---|---|---|---|---|---|
| Cathode Exhaust | | | | | | | |
| Flow Rate | kg/hr | 1096 | 2296 | 1329 | 334 | 334 | 2539 |
| Inlet Temperature | C. | 602 | 612 | 607 | 555 | 371 | 612 |
| Outlet Temperature | C. | 563 | 587 | 573 | 518 | 352 | 583 |
| Mixture | | | | | | | |
| Flow Rate | kg/hr | 124.7 | 162.4 | 122.0 | 25.4 | 25.4 | 242.2 |
| Inlet Temperature | C. | 215 | 216 | 203 | 125 | 159 | 242 |
| Outlet Temperature | C. | 400 | 400 | 400 | 400 | 294 | 400 |
| Fuel | | | | | | | |
| Flow Rate | kg/hr | 39.0 | 61.7 | 38.1 | 2.7 | 2.7 | 85.7 |
| Bypass | % | 0% | 0% | 0% | 0% | 0% | 0% |
| Delivered Fuel Cell Temp | C. | 400 | 400 | 400 | 400 | 294 | 400 |

Steam Generator

| | | | | | | | |
|---|---|---|---|---|---|---|---|
| Cathode Exhaust | | | | | | | |
| Flow Rate | kg/hr | 1096 | 2296 | 1329 | 334 | 334 | 2539 |
| Inlet Temperature | C. | 563 | 587 | 573 | 518 | 352 | 583 |
| Outlet Temperature | C. | 375 | 474 | 419 | 358 | 181 | 421 |
| Steam | | | | | | | |
| Flow Rate | kg/hr | 85.7 | 100.7 | 83.9 | 22.7 | 22.7 | 156.5 |
| Inlet Temperature | C. | 15 | 15 | 15 | 15 | 15 | 15 |
| Outlet Temperature | C. | 324 | 364 | 307 | 141 | 179 | 395 |
| dP | kPa | 59 | 86 | 64 | 8 | 6 | 128 |
| Water Bypass | | | | | | | |
| Percent | % | 3% | 6% | 7% | 14% | 0% | 0% |
| Flow Rate | kg/hr | 2.4 | 6.3 | 5.6 | 3.2 | 0.0 | 0.0 |

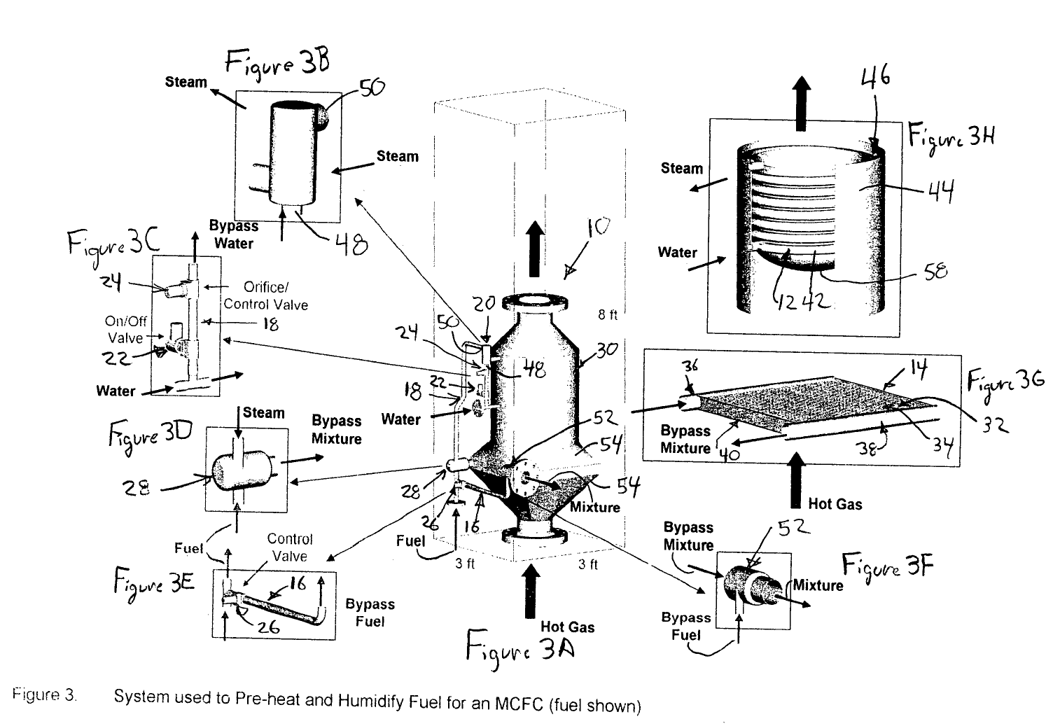

FIGS. 3A-3H show a possible embodiment of the total system, includes:
mixture heater 14
steam generator 12
fuel and water bypass control valves 22,24,26
attemperator (water/steam mixer) 20
steam/fuel mixers 28
miscellaneous line and branch connections
sheet metal housing 30.

Relative to the hot gas, the design shows the mixture heater 14 placed upstream of the steam generator 12. This is not essential to the design. Any combination of the mixture heater 14 placed upstream or downstream of the steam generator 12 and a co-current or counter-current generator 12 may be used.

Features of the mixture heater 14 included or potentially included in the design are:
multiple high-temperature strength and corrosion resistant alloy tubes 32 and fins 34 brazed together with headers 36,38 of the same or similar materials at the exit and entrance
one-pass design for each fluid to minimize pressure drop on both sides
CEG flows over the fin-side to reduce minor pressure drop losses due to nozzles/diffusers/connections
may be sized to fit in a cylinder of the same inside diameter of the steam coil 12
one-pass design allows for header to header growth (i.e., thermal expansion/contraction of tube/fins 32,34 along their length)
split side-piece 40 to reduce thermal constraints
header connections that allow for thermal expansion/contraction during start-up and/or operation (i.e., corrugated tubing, bellows, etc., attached to the header).

Features of the steam generator 12 included or potentially includes in the design are:
two-phase portion flows vertically upward through a helical-wound single-tube 42 to improve system stability
the addition of pressure-drop inducers at the inlet and/or exit of the water-side (i.e., orifices, twisted tape, etc.) to improve boiling stability
helical tube 42 allows for rapid thermal expansion/contraction associated with unstable boiling phenomena
single-tube 42 may or may not have a finned surface that may improve heat transfer and/or increase pressure drop
inlet and outlet connections may have fittings attached so that the coil 12 can be placed inside the outside cylinder 44 of the annulus 46 without interference prior to fastening the coil to the outside cylinder 44 (this allows for a one-piece cylinder 44, instead of two half shells with vertical welds)
coiled tube 42 is fastened to the outside cylinder 44 via welding, compression fittings, bulkhead unions, etc.
size of the outside cylinder 44 can be chosen to fit the mixture heater 14 inside
steam coil 12 could be multi-passed, but at the penalty of either hot gas pressure drop or boiling stability.

Features of the fuel and water bypass controls 22,24,26 include or potentially include:
variable flow controllers 22,24,26 (i.e., needle valves, pulsating valves, etc.) for both fuel and water bypass
the water bypass 18 without the fuel bypass 16
the water bypass 18 with the fuel bypass 16 could consist of an on/off valve 22 and a fixed pressure drop device 24 (i.e., orifice, nozzle, etc.), which that device allows for the correct amount of bypass (i.e., pressure drop in the coil matches pressure drop across the device).

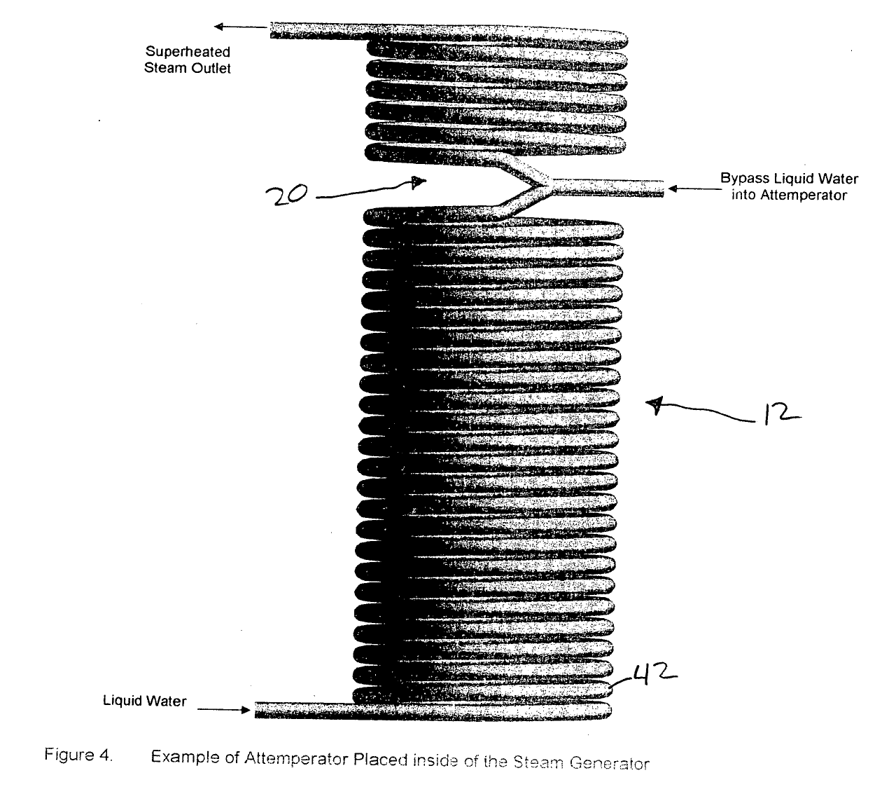

The attemperator 20 is used to control the steam outlet temperature. Its unique features included or potentially included in the design are:
location could be either external to the steam coil 12, or imbedded in the steam generator 12 (allows for better assurance of vaporization, see FIG. 4 for an example)
if external, liquid water and gaseous steam thoroughly mix together to produce superheated steam
if external, superheated steam exits the attemperator above the liquid water entrance 48 and stagnant level
if internal, the attemperator exit flow should be above the liquid water entrance 48 and stagnant level to improve stability
enhanced mixing, could be accomplished by the use of a cyclonic mixer, turbine stator, twisted tape, coiled tube, etc.
liquid water entrance 48 or stagnant level below the superheated steam exit 50.

Features of the fuel/steam mixers 28 include or potentially include:
enhanced mixing, produced by a cyclonic mixer, turbine stator, twisted tape, coiled tube, etc.
mixers upstream 28 and downstream 52 of the mixture heater to control the mixture exit temperature

The type of line and branch, and flanged entrance and exit connections are not integral to the design. Other connections could be used (i.e., compression fittings/branches, threaded fittings/branches, etc.).

The housing 30 shown in FIG. 3 is also not critical to the design. The features that could be incorporated include:
square to round transitions 54 upstream and downstream of the mixture heater
spun metal conical transitions
uniform diameter housing

Minimizing pressure drop could lead to poor distribution of either the fuel or hot gas streams. Flow straighteners (i.e., perforated sheets, conical diffusers, slotted discs, etc.) could be used to correct this problem.

When a helical tube steam generator 12 is used, it may be desirable to provide a domed shaped baffle 58 to direct the hot gas into the annulus 46.

The system 10 is particularly useful for supplying the fuel to a MCFC fuel cell system, shown schematically at 60.

1. A fuel humidifier/pre-heater unit for pre-heating and humidifying a fuel flow provided by a fuel supply, the unit comprising:
a steam generator including a water flow path in heat transfer relation with a hot fluid flow path to generate a vaporized water flow;
a water bypass;
a liquid/steam mixer connected downstream from the water flow path to receive the vaporized water flow therefrom and downstream from the water bypass to receive a liquid water flow therefrom; and
a mixture heater including a mixture flow path in heat transfer relation with a hot fluid flow path, the mixture flow path connected downstream from the liquid/steam mixer and the fuel supply.

2. The fuel humidifier/pre-heater of claim 1 wherein the hot fluid flow path of the steam generator is located downstream from the hot fluid flow path of the mixture heater with respect to a hot fluid flow.

3. The fuel humidifier/pre-heater of claim 1 wherein the hot fluid flow path of the mixture heater is located downstream from the hot fluid flow path of the steam generator with respect to a hot fluid flow.

4. The fuel humidifier/pre-heater of claim 1 further comprising a water bypass control valve connected upstream of the steam generator and the water bypass to selectively direct liquid water flows thereto.

5. The fuel humidifier/pre-heater of claim 1 wherein the steam generator and the liquid/steam mixer are an integrated unit.

6. The fuel humidifier/pre-heater of claim 1 wherein the liquid/steam mixer is located external from the steam generator.

7. The fuel humidifier/pre-heater of claim 1 further comprising a steam/fuel mixer connected downstream from the liquid/steam mixer to receive a superheated steam flow therefrom, downstream from the fuel supply to receive a fuel flow therefrom, and upstream from the mixture flow path to supply a steam/fuel mixture thereto.

8. The fuel humidifier/pre-heater of claim 1 further comprising:
a fuel bypass; and
a fuel/humidified fuel mixer connected downstream from the mixture heater to receive a humidified fuel flow therefrom and connected downstream from the fuel bypass to receive a fuel flow therefrom.

9. The fuel humidifier/pre-heater of claim 8 further comprising a fuel bypass control valve connected upstream from the fuel bypass and the mixture heater with respect to the fuel flow.

10. The fuel humidifier/pre-heater of claim 1 wherein said steam generator comprises a helical-wound tube with a water inlet and a steam outlet, the water inlet located vertically lower than the steam outlet.

11. A fuel cell system comprising:
a molten-carbonate fuel cell; and
a fuel humidifier/pre-heater unit for pre-heating and humidifying a fuel flow to the molten-carbonate fuel cell, the unit comprising
a steam generator including a water flow path in heat transfer relation with a hot fluid flow path to generate a vaporized water flow;
a water bypass;
a liquid/steam mixer connected downstream from the water flow path to receive the vaporized water flow therefrom and downstream from the water bypass to receive a liquid water flow therefrom; and
a mixture heater including a mixture flow path in heat transfer relation with a hot fluid flow path, the mixture flow path connected downstream from the liquid/steam mixer and a fuel supply.

12. The fuel cell system of claim 11 wherein the hot fluid flow path of the steam generator is located downstream from the hot fluid flow path of the mixture heater with respect to a hot fluid flow.

13. The fuel cell system of claim 11 wherein the hot fluid flow path of the mixture heater is located downstream from the hot fluid flow path of the steam generator with respect to a hot fluid flow.

14. The fuel cell system of claim 11 wherein the unit further comprises a water bypass control valve connected upstream of the steam generator and the water bypass to selectively direct liquid water flows thereto.

15. The fuel cell system of claim 11 wherein the steam generator and the liquid/steam mixer are an integrated unit.

16. The fuel cell system of claim 11 wherein the liquid/steam mixer is located external from the steam generator.

17. The fuel cell system of claim 11 wherein the unit further comprises a steam/fuel mixer connected downstream from the liquid/steam mixer to receive a superheated steam flow therefrom, downstream from the fuel supply to receive a fuel flow therefrom, and upstream from the mixture flow path to supply a steam/fuel mixture thereto.

18. The fuel cell system of claim 11 wherein the unit further comprises:
a fuel bypass; and
a fuel/humidified fuel mixer connected downstream from the mixture heater to receive a humidified fuel flow therefrom and connected downstream from the fuel bypass to receive a fuel flow therefrom.

19. The fuel cell system of claim 18 the unit further comprises a fuel bypass control valve connected upstream from the fuel bypass and the mixture heater with respect to the fuel flow.

20. A method for humidifying and pre-heating a fuel flow, the method comprising the steps of:
a) providing a fuel flow
b) providing a water flow for humidifying of a fuel flow;
c) modulating an amount of superheat of the water flow by heating a first portion of the supply water flow and mixing the heated first portion with a second portion of the supply water flow that has a lower temperature than the first portion;
d) mixing the water flow resulting from step c) with at least a first portion of the fuel flow to provide a mixture flow; and
e) heating the mixture flow.

21. The method of claim 20 wherein the heating of step c) and the heating of step e) are accomplished by transferring heat from a hot fluid flow to the water flow in step c) and the mixture flow in step e).

22. The method of claim 21 wherein the hot fluid flow transfers heat in step c) before it transfers heat in step e).

23. The method of claim 21 wherein the hot fluid flow transfers heat in step e) before it transfers heat in step c).

24. The method of claim 20 wherein step d) comprises mixing the water flow resulting from step c) with all of the fuel flow.

25. The method of claim 20 wherein step c) comprises selectively adjusting the first and second portions of the water flow to achieve a desired temperature for the mixture flow resulting from step e).

26. The method of claim 20 further comprising the step of:
f) modulating the temp of the humidified and pre-heated fuel flow by mixing the mixture flow resulting from step d) with a second portion of the fuel flow that has not been heated in step e).

27. The method of claim 26 wherein step f) further comprises selectively adjusting the first and second portions of the fuel flow to achieve a desired temperature for the mixture flow resulting from step f).

28. The method of claim 27 wherein step c) comprises selectively adjusting the first and second portions of the water flow to achieve the desired temperature for the mixture flow resulting from step f).

29. The method of claim 20 wherein step c) comprises superheating the first portion prior to mixing the first and second portions.
